(19) United States
(12) Patent Application Publication
(10) Pub. No.: US 2015/0249519 A1
(43) Pub. Date: Sep. 3, 2015

(54) WAVELENGTH MULTIPLEX APPARATUS, OPTICAL TRANSMISSION DEVICE, AND WAVELENGTH MULTIPLEX METHOD

(71) Applicant: FUJITSU LIMITED, Kawasaki-shi (JP)

(72) Inventor: Joji Terashi, Fukuoka (JP)

(21) Appl. No.: 14/612,339

(22) Filed: Feb. 3, 2015

(30) Foreign Application Priority Data
Feb. 28, 2014 (JP) 2014-039615

(51) Int. Cl. H04J 14/02

(52) U.S. Cl. CPC H04J 14/0227

(57) ABSTRACT

A wavelength multiplex apparatus includes TRPNs that output optical signals, VOAs that are provided in the TRPNs and regulate output levels of the signals from the TRPNs, a first CPL that multiplexes the regulated signals, an 0CM that detects the output levels of the multiplexed signals by the unit of wavelength, and a first control unit that, when an added signal is detected, controls a VOA for added signals so that an interference error with other signals is not caused and an output level of an signal falls within a detection range of output levels detectable in the OCM. The apparatus includes a monitoring unit that determines whether or not an output level of a set wavelength of the added signal is not less than a detection threshold within the range and a second control unit that controls the VOA for added signals on the basis of a determination result.

### CROSS-REFERENCE TO RELATED APPLICATION

This application is based upon and claims the benefit of priority of the prior Japanese Patent Application No. 2014-039615, filed on Feb. 28, 2014, the entire contents of which are incorporated herein by reference.

### FIELD

The embodiments discussed herein are directed to a wavelength multiplex apparatus, an optical transmission device, and a wavelength multiplex method.

### BACKGROUND

In an optical Wavelength Division Multiplex (WDM) transmission system, optical signals having a plurality of wavelengths are multiplexed by a Coupler (CPL) in each wavelength multiplex apparatus (each optical transmission device). The optical signals having the plurality of wavelengths are input from different input ports in some cases. In this case, at connection work before operation, for example, an operator erroneously connects optical fibers and/or erroneously sets a light wavelength of a newly added optical signal in some cases. Specifically, the added optical signal has a wavelength identical with that of an active optical signal during operation by mistake in some cases because of breakdown of an optical transmitter or other reasons. Furthermore, there is a possibility that the added optical signal is input to a CPL to which the active optical signal is input. In this case, signal interference occurs between the active optical signal and the added optical signal, and errors are caused in the active optical signal.

In view of this, there is known a technology of, in a case where an optical signal is added and the optical signal having a wavelength identical with that of an active optical signal is newly input in the wavelength multiplex apparatus, recovering from an error in the active optical signal by interrupting output of the added optical signal.

Patent Literature 1: Japanese Laid-open Patent Publication No. 2006-74098

A wavelength multiplex apparatus monitors output levels of optical signals having respective wavelengths and interrupts output of an added optical signal in a case where input of such an optical signal having a wavelength identical with that of an active optical signal is detected. However, the added optical signals are continuously output from an optical transmitter until output of the added optical signals is interrupted in the optical transmitter. Therefore, until the output of the added optical signals is interrupted, errors are also continuously caused in the active optical signal because of the added optical signals.

### SUMMARY

According to an aspect of the embodiments, a wavelength multiplex apparatus includes: a plurality of optical transmitting units, regulation units, a multiplex unit, a detection unit, a first control unit and a second control unit. The optical transmitting units output optical signals. The regulation units are included in the optical transmitting units, respectively, and regulate output levels of the optical signals output from the optical transmitting unit corresponding to each of the regulation units. The multiplex unit multiplexes the optical signals regulated in the regulation units. The detection unit detects by the unit of wavelength the output levels of the optical signals multiplexed in the multiplex unit. In a case where an optical signal to be set from the optical transmitting units is detected, the first control unit controls at least one of the regulation units that regulates an output level of the optical signal to be set so that the output level of the optical signal to be set falls within a detection range of output levels that do not cause an interference error with other optical signals output from the optical transmitting units. The second control unit controls at least one of the regulation units that regulates the output level of the optical signal to be set on the basis of an output level of a set wavelength relating to the optical signal to be set detected in the detection unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view illustrating an example of a wavelength multiplex apparatus of a first embodiment;

FIGS. 2A to 2C are explanatory views illustrating an example of optical signals when an added signal is normal;

FIGS. 3A to 3C are explanatory views illustrating an example of optical signals when an added signal is abnormal;

FIG. 4 is a timing chart illustrating an example of a processing operation when an added signal is normal in a wavelength multiplex apparatus;

FIG. 5 is a timing chart illustrating an example of a processing operation when an added signal is abnormal in a wavelength multiplex apparatus;

FIG. 6 is a flow chart illustrating an example of a processing operation of a wavelength multiplex apparatus regarding a VOA control processing; and

FIG. 7 is an explanatory view illustrating an example of a wavelength multiplex apparatus of a second embodiment.

### DESCRIPTION OF EMBODIMENTS

Preferred embodiments of the present invention will be explained with reference to accompanying drawings. Note that the disclosed technology is not limited by the embodiments. The following embodiments may be combined with each other as appropriate.

### [a] First Embodiment

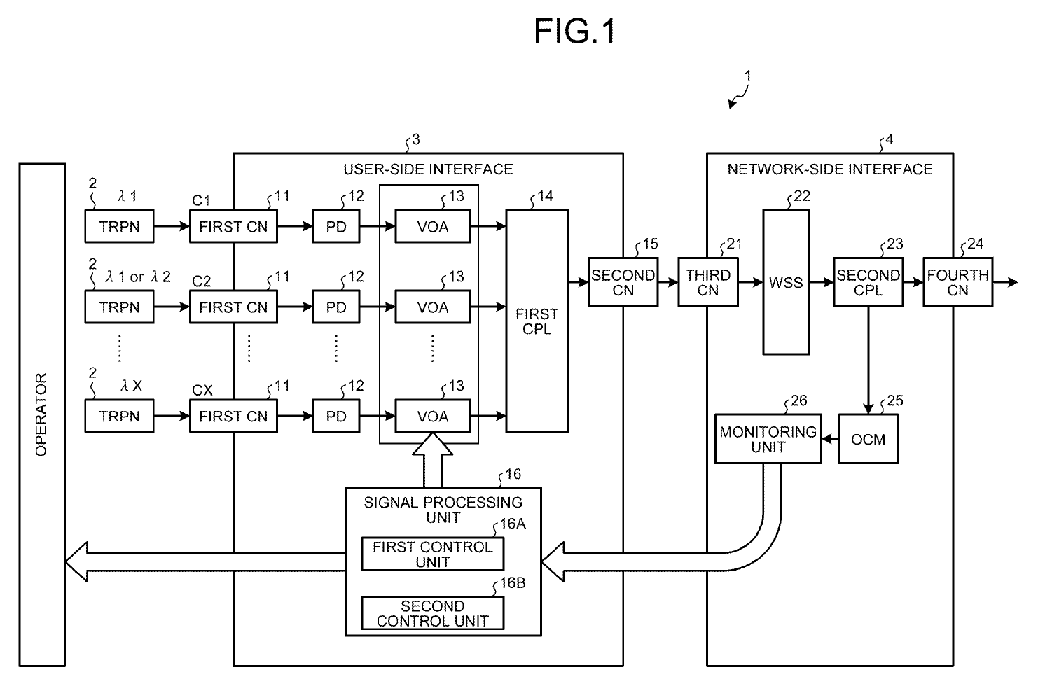

FIG. 1 is an explanatory view illustrating an example of a wavelength multiplex apparatus of a first embodiment. A wavelength multiplex apparatus 1 illustrated in FIG. 1 in an optical WDM transmission system includes a plurality of optical transmitting units (merely referred to as “TRPN”: Transponders) 2, a user-side interface portion 3, and a network-side interface portion 4. Each of the TRPNs 2 outputs an optical signal having a desired wavelength. The user-side interface portion 3 corresponds to an interface connected to the TRPNs 2. The user-side interface portion 3 includes first Connectors (CNs) 11, Photo Diodes (PDs) 12, Variable Optical Attenuators (VOAs) 13, a first Coupler (CPL) 14, a second Connector (CN) 15, and a signal processing unit 16.

The first CNs 11 correspond to connectors of ports connected for the respective TRPNs 2 and input optical signals from the TRPNs 2. The PDs 12 are photodiodes that receive the optical signals from the TRPNs 2 via the first CNs 11. The VOAs 13 are provided for the respective PDs 12 and are variable attenuators that attenuate output levels of the optical signals received by the PDs 12. The first CPL 14 is a coupler that outputs optical multiplex signals obtained by multiplexing the optical signals attenuated in the VOAs 13. The second CN 15 corresponds to a connector connected to the network-side interface portion 4 and outputs the optical multiplex signals multiplexed in the first CPL 14. The signal processing unit 16 controls the VOAs 13 so as to regulate an attenuation amount in the VOAs 13.

The network-side interface portion 4 corresponds to an interface connected to a network. The network-side interface portion 4 includes a third CN 21, a Wavelength Selective Switch (WSS) 22, a second CPL 23, a fourth CN 24, an Optical Channel Monitor (OCM) 25, and a monitoring unit 26. The third CN 21 is a connector that connects to the second CN 15 provided in the user-side interface portion 3. The WSS 22 is a wavelength selective switch that selects an optical signal having an arbitrary light wavelength from the optical multiplex signals input from the user-side interface portion 3 and output the optical signal. The second CPL 23 is a coupler that branches the optical signal having the arbitrary light wavelength. The fourth CN 24 is a connector that connects to the network. The OCM 25 is, for example, an optical spectrum analyzer that detects an output level of the optical signal having the arbitrary wavelength selected in the WSS 22 by the unit of wavelength.

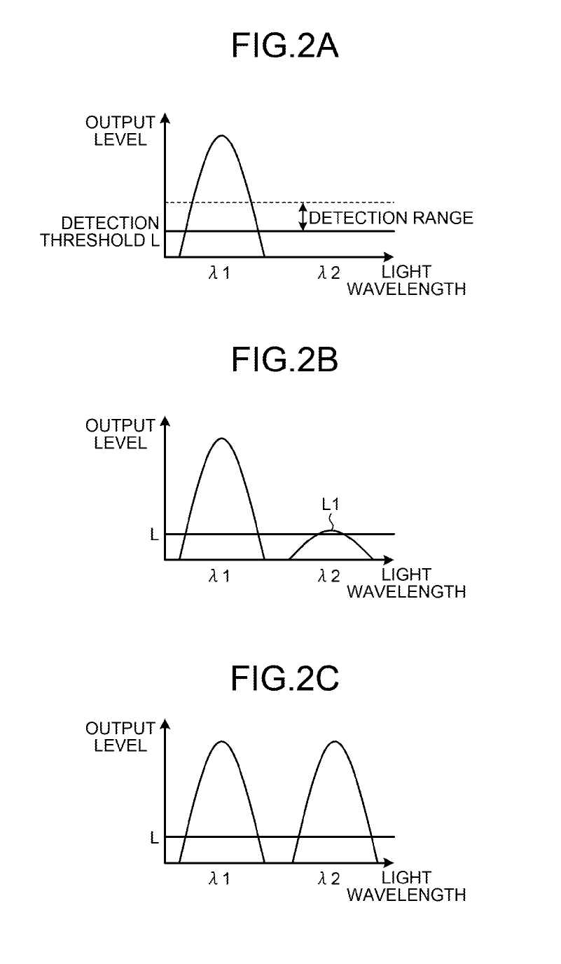

Based on a detection result of the OCM 25, the monitoring unit 26 monitors an output level of an added signal that is newly input. FIGS. 2A to 2C are explanatory views illustrating an example of optical signals when an added signal is normal. Note that a light wavelength of an active signal during operations is denoted by λ1 and a light wavelength of an added signal is denoted by λ2. The monitoring unit 26 acquires setting information in which the first CN 11 to serve as an input port of an added signal and light wavelength λ2 of the added signal are set in response to a setting operation from an operator. The monitoring unit 26 determines whether or not an output level of a set wavelength of the added signal is not less than a detection threshold L. Note that the detection threshold L corresponds to a reference level within a detection range within which an output level that does not cause an interference error with the active signal even in a case where the added signal has a wavelength identical with that of the active signal is set to be an upper limit and an output level of the added signal detectable in the OCM 25 is set to be a lower limit. The detection range is a range including a margin in consideration of variation of detection thresholds of individual OCMs 25 and variation of operated signals.

The monitoring unit 26 determines whether the added signal is abnormal or normal on the basis of a determination result on whether or not the output level of the set wavelength of the added signal is not less than the detection threshold L. As illustrated in FIGS. 2A and 2B, in a case where an output level L1 of the set wavelength λ2 of the added signal is not less than the detection threshold L, the monitoring unit 26 determines that the added signal is normal.

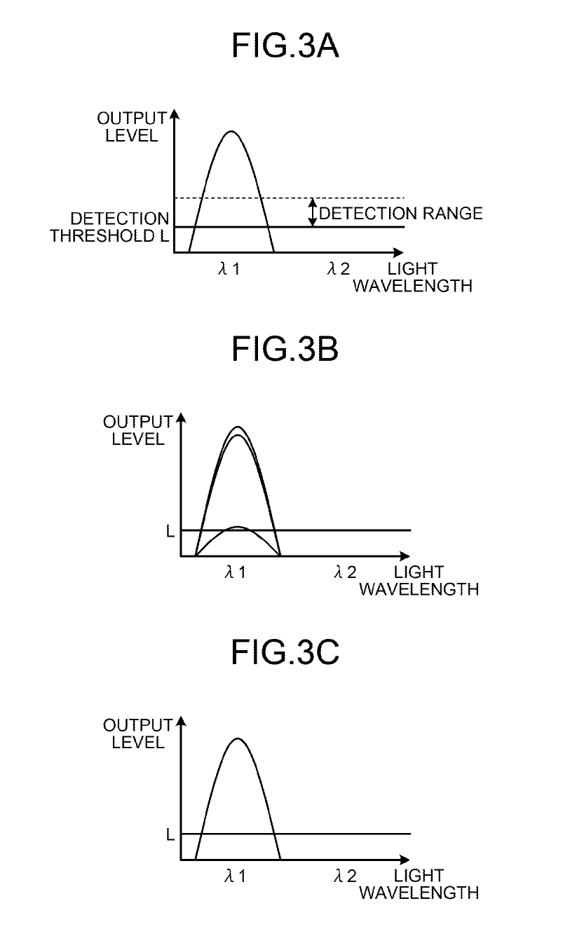

FIGS. 3A to 3C are explanatory views illustrating an example of optical signals when an added signal is abnormal. Note that it is assumed that, although a light wavelength of an active signal during operation is λ1 and a set wavelength of an added signal is λ2, the added signal having the light wavelength λ1 is output due to breakdown of the TRNP 2. As illustrated in FIGS. 3A and 3B, in a case where the output level of the set wavelength λ2 of the added signal is less than the detection threshold L, the output level of the set wavelength λ2 of the added signal that is normally output is not detected. Therefore, the monitoring unit 26 determines that the added signal is abnormal. Note that FIG. 3B illustrates a state in which, although the output level of the added signal becomes slightly large because the added signal having the light wavelength λ1 identical with that of the active signal is input, signal interference with the active signal because of input of the added signal is not caused because the output level of the added signal falls within the detection range.

The signal processing unit 16 includes a first control unit 16A and a second control unit 16B. The first control unit 16A and the second control unit 16B control a VOA 13 for added signals. Note that the VOA 13 for added signals, for example, associates with the TRPN 2 and the first CN 11 for outputting added signals, and is a VOA 13 that regulates an output level of the added signal. In a case where the added signal from the TRPN 2 is detected in the PD 12, the first control unit 16A controls the VOA 13 for added signals to attenuate the added signal so that the output level of the added signal falls within the detection range. The first control unit 16A causes the output level of the added signal to fall within the detection range by setting an attenuation amount in the VOA 13 for added signals to a predetermined attenuation amount.

In a case where it is determined that the added signal is normal on the basis of the determination result of the monitoring unit 26, the second control unit 16B controls the VOA 13 for added signals to return the output level of the added signal to a normal operation level as illustrated in FIG. 2C. In a case where it is determined that the added signal is abnormal on the basis of the determination result of the monitoring unit 26, the second control unit 16B controls the VOA 13 for added signals to interrupt output of the added signal as illustrated in FIG. 3C. Furthermore, in a case where it is determined that the added signal is abnormal, the second control unit 16B issues and outputs a warning for notifying abnormality of the added signal.

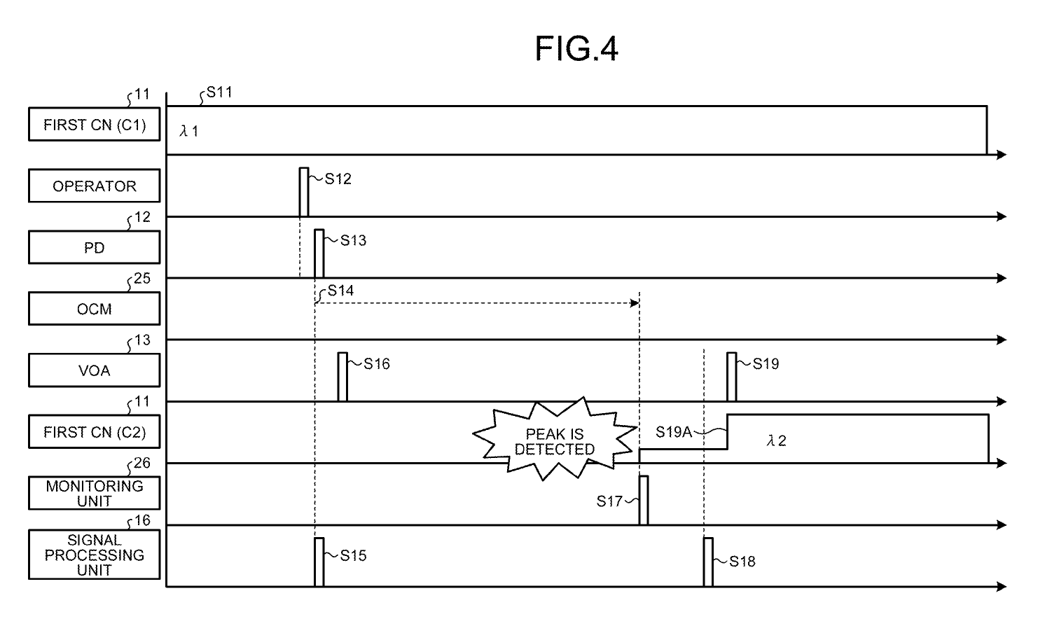

An operation of the wavelength multiplex apparatus 1 of the first embodiment will be described. FIG. 4 is a timing chart illustrating an example of a processing operation when an added signal is normal in the wavelength multiplex apparatus 1. Note that a light wavelength λ1 is set as an active signal during operation from the first CN 11 (C1) and a light wavelength λ2 is set as an added signal from the first CN 11 (C2). In FIG. 4, during operation of an optical signal having the light wavelength λ1 (step S11), the wavelength multiplex apparatus 1 sets setting information such as input of an added signal having the light wavelength λ2 to the first CN 11 (C2) for added signals from the TRPN 2 for added signals in response to a setting operation from an operator (step S12).

In a case where the added signal is detected via the PD 12 for added signals (step S13), the OCM 25 of the wavelength multiplex apparatus 1 starts counting of a prescribed time period relating to a monitoring time period of the OCM 25, the prescribed time period being a period needed to complete detection of an output level of a set wavelength of the added signal (step S14). Furthermore, in a case where the added signal is detected via the PD 12 for added signals in the step S13, the first control unit 16A of the wavelength multiplex apparatus 1 sets a predetermined attenuation amount in the VOA 13 for added signals (step S15). As a result, as illustrated in FIG. 2B, the VOA 13 for added signals attenuates the output level of the added signal so that the output level falls within the detection range on the basis of the predetermined attenuation amount (step S16).

After the prescribed time period of the monitoring time period of the OCM 25 has passed, the monitoring unit 26 of the wavelength multiplex apparatus 1 determines whether or not the output level of the set wavelength λ2 of the added signal from the TRPN 2 for added signals is not less than the detection threshold L. In a case where the output level of the set wavelength λ2 of the added signal is not less than the detection threshold L as illustrated in FIG. 2B, the monitoring unit 26 determines that the added signal is normal (step S17). In a case where it is determined that the added signal is normal, the second control unit 16B of the wavelength multiplex apparatus 1 sets the output level of the VOA 13 for added signals to the normal operation level (step S18). The VOA 13 for added signals outputs the added signal having the light wavelength λ2 by the normal operation level (steps S19, S19A).

In a case where the wavelength multiplex apparatus 1 that performs the processing illustrated in FIG. 4 detects the added signal, the wavelength multiplex apparatus 1 attenuates the output level of the added signal by a predetermined amount and, after the prescribed time period of the monitoring time period of the OCM 25 has passed, determines that the added signal is normal in a case where the output level of the set wavelength of the added signal is not less than the detection threshold L. Further, in a case where it is determined that the added signal is normal, the wavelength multiplex apparatus 1 can output the added signal having the operation level by setting the VOA 13 for the added signal to the normal operation level.

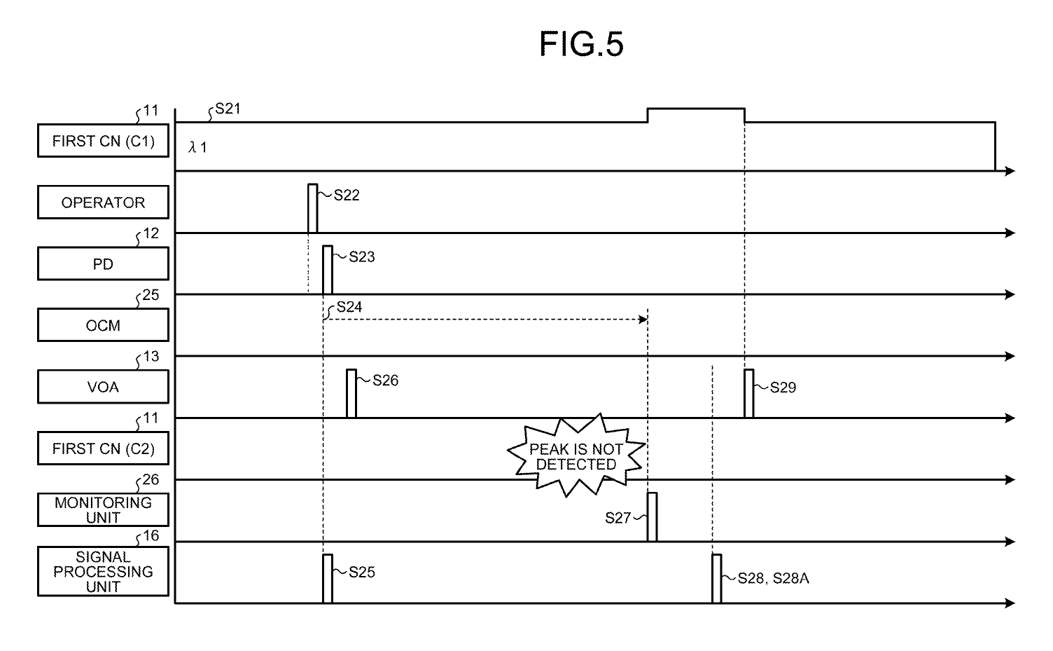

FIG. 5 is a timing chart illustrating an example of a processing operation when an added signal is abnormal in the wavelength multiplex apparatus 1. Note that it is assumed that a light wavelength λ1 is set as an active signal during operation from the first CN 11 (C1) and a light wavelength λ2 is set as a set wavelength of an added signal from the first CN 11 (C2), however, for example, an added signal having the light wavelength λ1 is output due to breakdown of the TRPN 2 for added signals.

During operation of an optical signal having the light wavelength λ1 (step S21), the wavelength multiplex apparatus 1 sets setting information such as input of an added signal having the set wavelength λ2 to the first CN 11 (C2) for added signals from the TRPN 2 for added signals in response to a setting operation from an operator (step S22).

In a case where the added signal is detected via the PD 12 for added signals (step S23), the OCM 25 of the wavelength multiplex apparatus 1 starts counting of the prescribed time period relating to the monitoring time period of the OCM 25 (step S24). Furthermore, in a case where the added signal is detected via the PD 12 for added signals in the step S23, the first control unit 16A of the wavelength multiplex apparatus 1 sets a predetermined attenuation amount in the VOA 13 for added signals (step S25). As a result, as illustrated in FIG. 3B, the VOA 13 for added signals attenuates the output level of the added signal so that the output level falls within the detection range on the basis of the predetermined attenuation amount (step S26).

After the prescribed time period of the monitoring time period of the OCM 25 has passed, in a case where the output level of the set wavelength of the added signal from the TRPN 2 for added signals is less than the detection threshold L, the monitoring unit 26 of the wavelength multiplex apparatus 1 determines that the added signal is abnormal (step S27). Note that, because the light wavelength of the added signal is not the light wavelength λ2 but is the light wavelength λ1, no added signal having the light wavelength λ2 which is the set wavelength exists, and therefore the monitoring unit 26 determines that the added signal is abnormal.

In a case where it is determined that the added signal is abnormal, the second control unit 16B of the wavelength multiplex apparatus 1 sets interruption of output of the added signal in the VOA 13 for added signals (step S28). In a case where it is determined that the added signal is abnormal, the second control unit 16B issues and outputs a warning for notifying abnormality of the added signal (step S28A). As a result, an operator can recognize the abnormality of the added signal by issue and output of the warning.

The VOA 13 for added signals interrupts the outputs of the added signal in response to the setting of interruption of the output of the added signal from the second control unit 16B (step S29). As a result, in a case where the added signal is abnormal, the wavelength multiplex apparatus 1 interrupts the output level of the added signal.

In a case where the wavelength multiplex apparatus 1 that performs the processing illustrated in FIG. 5 detects the added signal, the wavelength multiplex apparatus 1 attenuates the output level of the added signal by a predetermined amount and, after the prescribed time period of the monitoring time period of the OCM 25 has passed, determines that the added signal is abnormal in a case where the output level of the set wavelength of the added signal is less than the detection threshold L. Further, in a case where it is determined that the added signal is abnormal, the wavelength multiplex apparatus 1 interrupts output of the added signal by setting interruption of output in the VOA 13 for the added signal. As a result, even if the added signal having the wavelength identical with that of the active signal is input, the output level of the added signal is attenuated to fall within the detection range, and therefore the wavelength multiplex apparatus 1 can prevent signal interference with the active signal because of input of the added signal even before output of the added signal is interrupted.

In a case where it is determined that the added signal is abnormal, the wavelength multiplex apparatus 1 issues and outputs a warning for notifying abnormality of the added signal to an operator. Therefore, the operator can recognize the abnormality of the added signal by the warning.

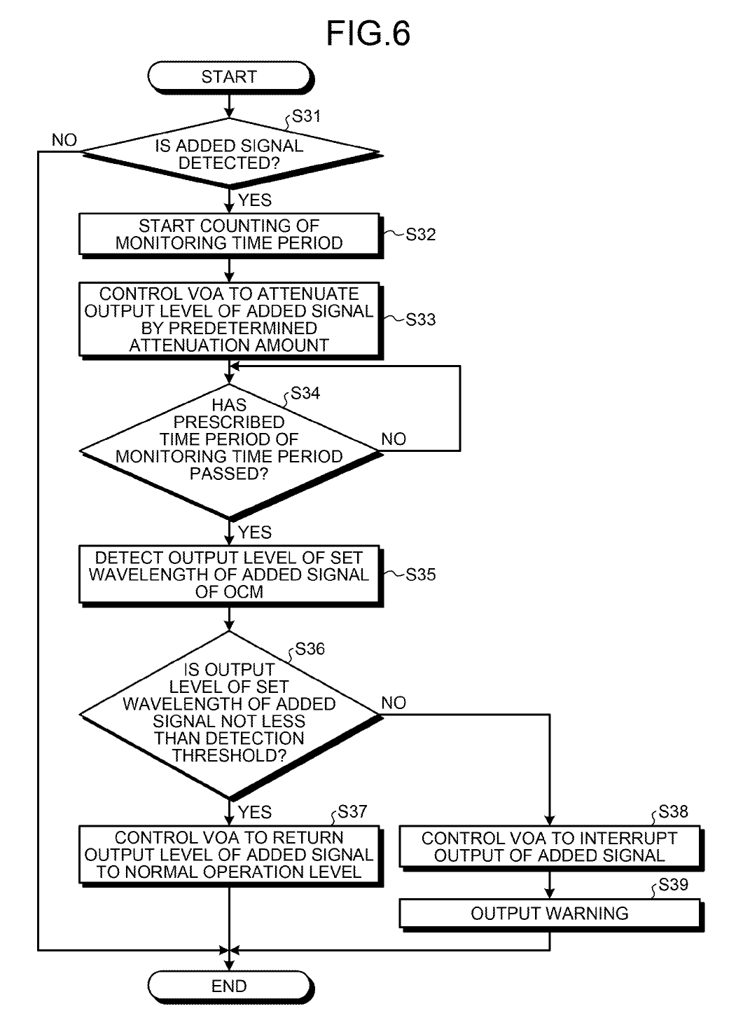

FIG. 6 is a flow chart illustrating an example of a processing operation of the wavelength multiplex apparatus 1 regarding VOA control processing. The VOA control processing illustrated in FIG. 6 is processing that controls the VOA for added signals to interrupt the output of the added signal in a case where it is determined that the added signal is abnormal and controls the VOA to return the output of the added signal to the operation level in a case where it is determined that the added signal is normal.

The monitoring unit 26 of the wavelength multiplex apparatus 1 determines whether or not the added signal is detected via the PD 12 (step S31). In a case where the added signal is detected (Yes in step S31), the monitoring unit 26 starts counting of a prescribed time period of the monitoring time period of the OCM 25 (step S32). The first control unit 16A of the wavelength multiplex apparatus 1 controls the VOA 13 for added signals to attenuate the output level of the added signal by the predetermined attenuation amount so that the output level falls within the detection range (step S33).

After the first control unit 16A controls the VOA 13 for added signals, the first control unit 16A determines whether or not the prescribed time period of the monitoring time period of the OCM 25 has passed (step S34). In a case where the prescribed time period of the monitoring time period of the OCM 25 has passed (Yes in step S34), the second control unit 16B of the wavelength multiplex apparatus 1 detects the output level of the set wavelength of the added signal of the OCM 25 (step S35). The second control unit 16B determines whether or not the output level of the set wavelength of the added signal is not less than the detection threshold L (step S36).

In a case where the output level of the set wavelength of the added signal is not less than the detection threshold L (Yes in step S36), the second control unit 16B determines that the added signal is normal and controls the VOA 13 for added signals to return the output level of the added signal to the normal operation level (step S37).

After the second control unit 16B controls the VOA 13 for added signals to return the output level of the added signal to the normal operation level, the processing operation illustrated in FIG. 6 is terminated.

In a case where the output level having the set wavelength for added signals is less than the detection threshold L (No in step S36), the second control unit 16B determines that the added signal is abnormal and controls the VOA 13 for added signals to interrupt output of the added signal (step S38). Furthermore, after the output of the added signal is interrupted, the second control unit 16B issues and outputs a warning for notifying abnormality of the added signal (step S39), and the processing operation illustrated in FIG. 6 is terminated. As a result, an operator can recognize the abnormality of the added signal by the warning.

In a case where the added signal is not detected (No in step S31), the monitoring unit 26 terminates the processing operation illustrated in FIG. 6. In a case where the prescribed time period of the monitoring time period has not passed (No in step S34), the monitoring unit 26 proceeds to step S34 in order to monitor whether or not the prescribed time period of the monitoring time period has passed.

In a case where the wavelength multiplex apparatus 1 detects the added signal, the wavelength multiplex apparatus 1 attenuates the output level of the added signal by the predetermined amount and, after the prescribed time period of the monitoring time period of the OCM 25 has passed, determines that the added signal is normal in a case where the output level of the set wavelength of the added signal is not less than the detection threshold L. Further, in a case where it is determined that the added signal is normal, the wavelength multiplex apparatus 1 sets the output level of the VOA 13 for the added signal to the normal operation level, and therefore the wavelength multiplex apparatus 1 can output the added signal. As a result, even if the added signal having the wavelength identical with that of the active signal is input, the output level of the added signal is first attenuated to fall within the detection range, and therefore the wavelength multiplex apparatus 1 can prevent signal interference with the active signal because of input of the added signal even before output of the added signal is interrupted.

In a case where the wavelength multiplex apparatus 1 detects the added signal, the wavelength multiplex apparatus 1 attenuates the output level of the added signal by the predetermined amount and, after the prescribed time period of the monitoring time period of the OCM 25 has passed, determines that the added signal is abnormal in a case where the output level of the set wavelength of the added signal is less than the detection threshold L. Further, in a case where it is determined that the added signal is abnormal, the wavelength multiplex apparatus 1 interrupts output of the added signal in the VOA 13 for the added signal. As a result, even if the added signal having the wavelength identical with that of the active signal is input, the output level of the added signal is first attenuated to fall within the detection range, and therefore the wavelength multiplex apparatus 1 can prevent signal interference with the active signal because of input of the added signal even before output of the added signal is interrupted when the added signal is abnormal. That is, it is possible to prevent the signal interference of coherent crosstalk with the active signal because of input of the added signal.

In a case where it is determined that the added signal is abnormal, the wavelength multiplex apparatus 1 issues and outputs a warning for notifying abnormality of the added signal to an operator. Therefore, the operator can recognize the abnormality of the added signal by the warning.

The wavelength multiplex apparatus 1 of the first embodiment is configured such that the user-side interface portion 3 and the network-side interface portion 4 are provided to be 1:1. However, the wavelength multiplex apparatus may be configured such that a plurality of user-side interface portions are provided and are monitored by a single network side interface portion, i.e., the user-side interface portions and the network-side interface portions are provided to be plurality:one. An embodiment of this case will be described below as a second embodiment.

### [b] Second Embodiment

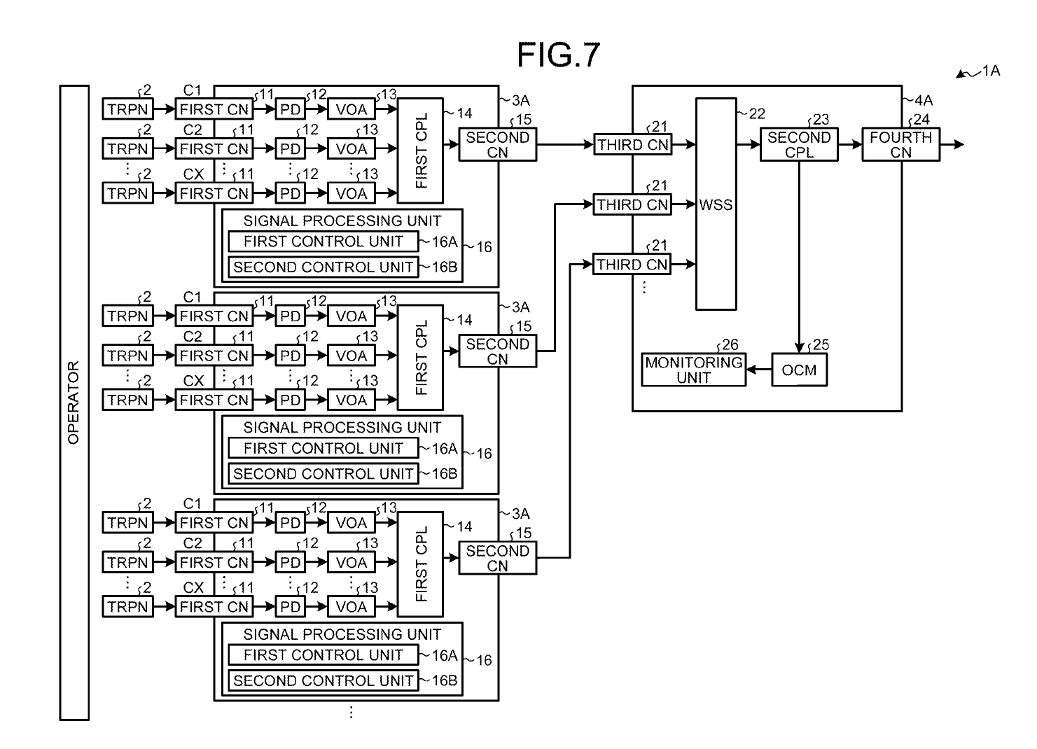

FIG. 7 is an explanatory view illustrating an example of a wavelength multiplex apparatus of a second embodiment. Note that members having the same configuration as that of the wavelength multiplex apparatus 1 illustrated in FIG. 1 are denoted by the same reference signs and repeated description of the configuration and the operation will be omitted. A wavelength multiplex apparatus 1A illustrated in FIG. 7 includes a plurality of user-side interface portions 3A, and a monitoring unit 26 of a network-side interface portion 4A determines whether or not an output level of a set wavelength of an added signal is not less than a reference level.

In response to a setting operation from an operator, the monitoring unit 26 of the network-side interface portion 4A acquires setting information such as an input port of the added signal on each user-side interface portion 3A side and a set wavelength of the added signal.

The monitoring unit 26 determines whether or not the output level of the set wavelength of the added signal is not less than the reference level on the basis of the setting information. The monitoring unit 26 determines whether the added signal is abnormal or normal on the basis of a determination result on whether or not the output level of the set wavelength of the added signal is not less than the reference level. Then, the monitoring unit 26 notifies the determination result on abnormality or normality of the added signal to the user-side interface portion 3A for added signals.

In a case where it is determined that the added signal is abnormal on the basis of the determination result of the monitoring unit 26, the second control unit 16B in the signal processing unit 16 of the user-side interface portion 3A for added signals controls the VOA 13 for added signals to interrupt output of the added signal. In a case where it is determined that the added signal is normal, the second control unit 16B controls the VOA 13 for added signals to return the output level of the VOA 13 for added signals to the normal operation level.

Even in a case where an added signal having a wavelength identical with that of the active signal is input among the plurality of user-side interface portions 3A, the wavelength multiplex apparatus 1A of the second embodiment determines whether the added signal is normal or abnormal with the use of the monitoring unit 26 of the single network-side interface portion 4A. The monitoring unit 26 of the wavelength multiplex apparatus 1A notifies a determination result thereof to the signal processing unit 16 of the user-side interface portion 3A for added signals. Then, in a case where the added signal is normal on the basis of the determination result, the signal processing unit 16 of the user-side interface portion 3A for added signals can control the VOA 13 for added signals to return the output level of the VOA 13 for added signals to the normal operation level of the added signal.

In a case where the added signal is abnormal on the basis of the determination result, the signal processing unit 16 of the user-side interface portion 3A for added signals can control the VOA 13 for added signals to interrupt output of the added signal. As a result, even if the added signal having the wavelength identical with that of the active signal is input, the output level of the added signal is attenuated to fall within the detection range, and therefore the wavelength multiplex apparatus 1A can prevent signal interference with the active signal because of input of the added signal even before output of the added signal is interrupted.

Even in a case where the wavelength multiplex apparatus 1A includes the plurality of user-side interface portions 3A, the wavelength multiplex apparatus 1A needs only the OCM 25 and the monitoring unit 26 of the single network-side interface portion 4A. Therefore, a circuit configuration thereof is not complicated, so that the wavelength multiplex apparatus 1A is advantageous in terms of a mounting area and costs thereof.

Note that the above examples have exemplified a case where the added signal having the wavelength identical with the light wavelength of the active signal is input because of breakdown of the TRPNs 2. However, the above examples are even applicable to a case where the added signal having the wavelength identical with the light wavelength of the active signal is input because, for example, an operator erroneously connects optical fibers or erroneously sets the light wavelength of the added signal.

The above embodiments have exemplified by applying a newly added signal, however, the added signal is not limited thereto. An operator may designate an optical signal to be set among a plurality of optical signals and apply this designated optical signal to be set.

In the above embodiments, in a case where it is determined that the added signal is abnormal, output of the added signal is interrupted by the VOA 13 for added signals, however, output of the optical signal from the TRPN 2 for added signals is stopped.

Further, the above embodiments have exemplified the wavelength multiplex apparatus, however, the above examples are applicable to an optical transmission device including the wavelength multiplex apparatus.

The components of the units illustrated in the drawings do not always need to be physically configured as illustrated in the drawings. That is, a specific configuration in which the units are dispersed or integrated is not limited to the illustrated configuration. The units may be configured by functionally or physically dispersing or integrating all or a part of the units in arbitrary units according to various loads, usage patterns, or the like.

Furthermore, all or an arbitrary part of the various processing functions performed in the units may be implemented by a Central Processing Unit (CPU) (or a microcomputer such as Micro Processing Unit (MPU) and MCU (Micro Controller Unit (MCU)). Further, as a matter of course, all or an arbitrary part of the various processing functions may be implemented by a program to be analyzed and executed by the CPU (or a microcomputer such as MPU and MCU) or as hardware based on a wired logic.

It is possible to prevent signal interference caused by input of an optical signal to be set.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wavelength multiplex apparatus, comprising:
a plurality of optical transmitting units that output optical signals;
regulation units that are included in the optical transmitting units, respectively, and regulate output levels of the optical signals output from the optical transmitting unit corresponding to each of the regulation units;
a multiplex unit that multiplexes the optical signals regulated in the regulation units;
a detection unit that detects by the unit of wavelength the output levels of the optical signals multiplexed in the multiplex unit;
a first control unit that, in a case where an optical signal to be set from the optical transmitting units is detected, controls at least one of the regulation units that regulates an output level of the optical signal to be set so that the output level of the optical signal to be set falls within a detection range of output levels that do not cause an interference error with other optical signals output from the optical transmitting units; and
a second control unit that controls at least one of the regulation units that regulates the output level of the optical signal to be set on the basis of an output level of a set wavelength relating to the optical signal to be set detected in the detection unit.

2. The wavelength multiplex apparatus according to claim 1, further comprising
a determination unit that determines whether or not the output level of the set wavelength relating to the optical signal to be set is not less than a reference level within the detection range, wherein
the second control unit controls at least one of the regulation units that regulates the output level of the optical signal to be set on the basis of a determination result of the determination unit.

3. The wavelength multiplex apparatus according to claim 2, wherein
the second control unit
controls at least one of the regulation units to interrupt output of the optical signal to be set in a case where the output level of the set wavelength relating to the optical signal to be set is less than the reference level on the basis of the detection result of the detection unit and
controls at least one of the regulation units to regulate the output level of the optical signal to be set to a normal operation level in a case where the output level of the set wavelength relating to the optical signal to be set is not less than the reference level.

4. The wavelength multiplex apparatus according to claim 1, wherein
the first control unit controls at least one of the regulation units that regulates the output level of the optical signal to be set so that the output level of the optical signal to be set falls within the detection range including an output level detectable in the detection unit.

5. The wavelength multiplex apparatus according to claim 2, wherein
the determination unit determines whether or not the output level of the set wavelength relating to the optical signal to be set is not less than the reference level after a predetermined time has passed from a timing at which the optical signal to be set is detected.

6. The wavelength multiplex apparatus according to claim 4, wherein
the determination unit determines whether or not the output level of the set wavelength relating to the optical signal to be set is not less than the reference level after a predetermined time has passed from a timing at which the optical signal to be set is detected.

7. An optical transmission device, comprising:
a plurality of optical transmitting units that output optical signals;
regulation units that are included in the optical transmitting units, respectively, and regulate output levels of the optical signals output from the optical transmitting unit corresponding to each of the regulation units;
a multiplex unit that multiplexes the optical signals regulated in the regulation units;
a detection unit that detects by the unit of wavelength the output levels of the optical signals multiplexed in the multiplex unit;
a first control unit that, in a case where an optical signal to be set from the of optical transmitting units is detected, controls at least one of the regulation units that regulates an output level of the optical signal to be set so that the output level of the optical signal to be set falls within a detection range of output levels that do not cause an interference error with other optical signals output from the optical transmitting units; and
a second control unit that controls at least one of the regulation units that regulates the output level of the optical signal to be set on the basis of an output level of a set wavelength relating to the optical signal to be set detected in the detection unit.

8. A wavelength multiplex method performed by a wavelength multiplex apparatus including: a plurality of optical transmitting units that output optical signals; regulation units that are included in the optical transmitting units, respectively, and regulate output levels of the optical signals output from the optical transmitting unit corresponding to each of the regulation units; a multiplex unit that multiplexes the optical signals regulated in the regulation units; and a detection unit that detects by the unit of wavelength the output levels of the optical signals multiplexed in the multiplex unit, wherein
the method comprises:
in a case where an optical signal to be set from the optical transmitting units is detected, controlling at least one of the regulation units that regulates an output level of the optical signal to be set so that the output level of the optical signal to be set falls within a detection range of output levels that do not cause an interference error with other optical signals output from the optical transmitting units and
controlling at least one of the regulation units that regulates the output level of the optical signal to be set on the basis of an output level of a set wavelength relating to the optical signal to be set detected in the detection unit.
